(19) United States
(12) Patent Application Publication
(10) Pub. No.: US 2026/0089154 A1
(43) Pub. Date: Mar. 26, 2026

(54) System and Method for Automation Device Configuration

(71) Applicant: OliverIQ, Sandy, UT (US)

(72) Inventors: Eric Smith, Draper, UT (US); Jory Dunn, West Jordan, UT (US); Spencer Apsley, Lehi, UT (US); Michael Thomas Patrick McNamara, Salt Lake City, UT (US); Darrell Burns, Kaysville, UT (US)

(21) Appl. No.: 19/337,732

(22) Filed: Sep. 23, 2025

Related U.S. Application Data
(60) Provisional application No. 63/697,949, filed on Sep. 23, 2024.

(51) Int. Cl. H04L 9/40

(52) U.S. Cl. CPC H04L 63/083; H04L 63/102

(57) ABSTRACT

This technology includes a method for executing a configuration process for an automation device. The method can include detecting an automation device on a computer network using a bridge agent associated with an automation hub. Another operation is determining the configuration process used to configure the automation device for operating with the bridge agent by using automation device identification information obtained by the bridge agent. Execution the configuration process may be initiated, which is to be executed by a client application. Donfiguration information for the automation device may be received from the client application.

### BACKGROUND

The wide availability of automation devices (e.g., automated lights, light switches, motion detectors, garage door controllers, etc.), video cameras, large screen TVs, wireless audio equipment, IoT (internet of things) devices, and other electronic automation equipment has continued to increase interest in having and maintaining an automation network for home, business or public locations. Over time it has become less expensive and easier to buy many networkable automation components that can be used to control lighting, HVAC, garage doors, appliances, stream video or music, and automate a variety of other electronic components using an automation network.

Many automation devices, entertainment systems, security systems and other electronic devices can be networked into a central controller or automation hub through a wired or wireless network. Examples of electronic components that an individual may desire to interface with a central controller and an automation network can include: television screens, wireless audio equipment, video cameras, microphones, audio-visual and entertainment equipment, Alexa devices, Google devices, etc. Other types of devices that can be in communication with the central controller or automation hub can include automation equipment such as: door locks, lighting control switches, fireplace relays, dimmers, thermostats, HVAC, timers, garage door controllers, alarm systems, security systems and other types of automation equipment. In addition, other home or business equipment can be connected to a central controller or automation hub of an automation network such as: USB devices, FireWire devices, serial and parallel communication devices, fiber optic connections, a computer network using an Ethernet or wireless connection, and Internet connections. These electronic components that have been described can be used many settings, including home, business, education, government, hotels, churches, and entertainment facilities.

### BRIEF DESCRIPTION OF THE DRAWINGS

FIG. 1 is a block diagram illustrating an example of an automation hub that can detect an automation device and determine what process applies to configuring the automation device.

FIG. 2 is an example block diagram illustrating a bridge agent executing on an automation hub to discover what automation devices are on the network and to configure the automation devices.

FIG. 3 is a block diagram illustrating an example of multiple types of gateways that may be connected to an automation hub.

FIG. 4 is a flowchart illustrating an example a method for determining a configuration process for an automation device.

FIG. 5 is a block diagram of a service provider environment according to an example of the present technology.

FIG. 6 is a block diagram that provides an example illustration of a computing device that may be employed in the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology provides a system with bridge agents and drivers that instruct a client application to provide user interface elements to obtain or collect configuration information to get a detected automation device configured to operate with an automation hub. The configuration information may include obtaining: user name and password information, Oauth authorization, 2 factor authentication (2FA), clicking a physical button or other types of configuration information which may be obtained.

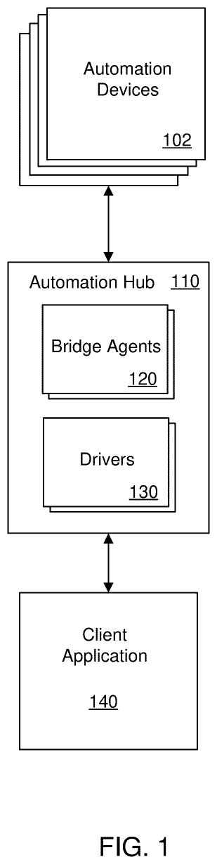

FIG. 1 illustrates an automation hub 110 that can detect an automation device 102 and determine a process that applies to configuring the automation device 102 to work with the automation hub 110, driver 130 and/or bridge agent 120. Initially, the automation hub 110 can discover an automation device 102 that is not connected to a network but not configured for use with the automation hub 110. The automation hub 110 can also recognize what type of automation device 102 has been discovered (e.g., a Lutron device, a Google device, an Alexa device, etc.) and the functionality of the automation device 102. The automation hub 110 can query the user of the automation hub 110 and ask if the user wants to add this automation device 102 to the automation hub 120.

Based on the vendor type and/or functionality of the automation device (e.g., the vendor type is Lutron, the device type is a light switch), this information is used to determine which driver 130 and/or bridge agent 120 the automation device 110 may use. Accordingly, the appropriate bridge agent 120 and/or driver 130 can be loaded into the automation hub 110 for that specific automation device 102, if not already loaded. The bridge agent 120 knows how to talk to services in the cloud or locally to the automation device 110. The bridge agent 120 can then provide the elements of the configuration process to a client application 140. For example, configuring and connecting the automation device may include configuring a local device where a user pushes a button on an automated light switch (e.g., a Lutron device) and the light switch is configured to connect to the automation hub 110 which can then control the light switches functionality. In another configuration, the bridge agent 120 may have to perform Oauth operations to obtain a token or two factor authentication (2FA) in order to configure and control the automation device 102 using the automation hub 110.

The bridge agents 120 that are loaded can guide the user interface of a client application 140 through the process of configuration. The bridge agent 120 can configure automation devices 102 regardless of the different configuration processes separate devices may use. Because this configuration process information is sent from the bridge agent 120 to the client application 140, the client application 140 then knows the protocol and user interface for connecting to and/or configuring a light as each step occurs. A driver 130 for the automation device 102 may translate the process to a protocol of a vendor of the automation device and use the bridge to encapsulate the messages and to get the messages to the gateway and ultimately the automation device 102 being configured. In the past, the client application 140 and UI had to know how to configure each automation device. The communication of the configuration process operations or actions between the bridge agent 120 and client application 140 provides the UI steps and/or any related information. This way the client application 140 does not need to know the configuration process details for a Lutron dimmer because the process details are provided by the bridge agent 120. The client application will know, in advance, the automation device (e.g., a dimmable light) has colors, light balance, dimming, ramp rates, etc. However, the bridge agent 120 knows what to send to the client application 140 to perform configuration for the automation devices 102. By comparison, the client sends the same message for a light operation regardless of what type of light the automation device is and the architecture (i.e., the driver and bridge agent) translates commands into the correct protocol for the light. However, the configuration process may be different for every automation device 102.

For example, the bridge agent 120 can tell the client application 140 to present a box control in the user interface to collect a password, two factor authentication (2FA) value or to touch a button to configure the automation device 102. The process for configuration of the automation device 102 may have any number of possible operations and the bridge agent 120 may walk the client application 140 through the configuration process. The bridge agent 120 can track the active point in the configuration process and can walk the client application 140 through the process for configuring the automation device 102. Providing the configuration process using the bridge agents 120 also allows for any changes or new configuration operations to be added. If a new operation is created for entering a code into a client application, then the configuration process may allow for such a new change. If biometrics or scanning of a QR code is included in a configuration process, then that step can be provided to the client application 140 from the revised bridge agent 120.

A bridge agent 120 may be provided for each service provider or vendor. The bridge agent 120 may be programmed with the process to tell the client application 140 how to get the automation device 102 online (e.g., configured for the bridge agent 120 to control) and how to add new automation devices. The type of automation device 102 detected can be used to determine what bridge agent 120 to load and the process to connect to the bridge agent 120. The configuration process may include how to connect to and configure the automation device 102 and this may include authentication to a service, two factor authentication (2FA), pressing a button, entering password, or a variety of other operations. The bridge agent 120 may know how to query a hardware bridge for a vendor to find out what devices are behind the hardware bridge.

If new devices are added, then those devices may be brought in to the automation hub 110 too. If new devices are detected and no bridge agent 120 is available and loaded for that automation device type then the appropriate bridge agent(s) 120 can be loaded. For example, a Nest thermostat might be discovered and then the Nest bridge agent may be loaded. Thus, a determination may be made as to which bridge agent 120 may need to be loaded (if any) in response to a particular device being detected. Next, the process for configuring the automation device 102 and connecting to the bridge agent to control the automation device 102 may be executed. This configuration may include authentication to a third party resource server (e.g. Oauth) or a user may have to push a button, put in a code, perform two factor authentication (2FA), enter a user name and password, do nothing, or just click a button and say add the automation device. The bridge agent 120 can provide operations for prompting the user to do what the user needs to do and when to do the action. Using a process stored in the bridge agent 120 is useful because otherwise a manufacturer of the automation system would have to push out a new client application 140 each time a new bridge agent was created. The new bridge agent that is created may be a plug-in.

This same process can be used to enable configuration by any bridge agent 120 to connect to and configure and control automation devices 102. As explained, a bridge agent 120 may be a plug-in that can be loaded by the automation hub 110 when a connection to and control of an automation device 102 is desired to be added. A separate bridge agent 120 may exist for a specific vendor (e.g., Lutron, Google, Sonos, etc.), a device function (e.g., light switches or garage door automation), a protocol type (e.g., Zigbee or Z-wave), a control type (e.g., app control, voice control, AI control), a set mixture of types or another grouping of automation devices. The bridge agent 102 can communicate with a network of devices based on the bridge agent 102 type.

The bridge agent 120 can use standard SSTP (Secure Socket Tunneling Protocol), Simple Service Discovery Protocol (SSDP) in Universal Plug and Play (UPNP) to discover network devices or other device discovery services or protocols on a network. Alternatively, the user can select an automation device 102 to add from a list or using a query. The user may also enter into the device add interface that the user wants to add a Nest or Leviton device and then that device may be added to the automation hub's 110 list of devices that are connected and controllable by the automation hub 110.

Some automation devices 102 may not be discoverable, so then the user can tell the automation hub 110 that the user knows details about the device that is on the network. For example, a user may tell the automation hub 110 that the user has: a Nest thermostat, Sonos speaker or another device. and the automation hub 110 can connect to and configure the device.

In another example, some devices do not broadcast their existence on the computer network. In this situation, the automation hub 110 can look at DHCP tables and find MAC addresses for automation devices. Because there may be a MAC block that is assigned to a particular company, such as a Z-wave device, then the MAC address can identify the device's vendor. The automation hub or process may put the Z-wave device into inclusion mode or add mode. Then a wireless broadcast is sent to talk to the Z-wave device. The Z-wave device is told to allow new device joins and the user touches a button on the device and the device can join the automation hub 110.

This technology may also provide processes and systems to discover and configure any OAuth (Open Authorization) service for an OAuth enabled automation device by using software on premises (e.g., in an automation hub) and/or in a public service provider environment (e.g., the cloud). OAuth is a protocol designed to allow a web application or local application to access resources hosted by other web applications or services on behalf of a user. OAuth is primarily a means of authorization or granting access to a set of resources, for example, remote APIs or user data on behalf of an end user. OAuth is generally not an authentication technology for authenticating an individual. However, OAuth can be used to authenticate to remote services or cloud services provided by vendors of automation devices in order to access and control such automation devices.

OAuth is an authorization framework that allows a user to consent to an application or web application interacting with another application or web application on the user's behalf without having to reveal the user's password. For example, a user can allow an automation hub or automation cloud service to access or control an automation device (e.g., a NEST thermostat) through the vendor's cloud services (e.g., NEST's cloud service for the device) without giving the automation hub or automation cloud service their password controlled by the automation device's vendor. This is generally performed by obtaining tokens or access tokens to third-party services (e.g., Google) without exposing user credentials.

An automation device may be named and put into a space. A space is a tag that is more generic than a room. If a user sets up a Lutron device and sets the device up as the living room chandelier, then later the user can re-name the device and associate the device with a space. An automation device can be in multiple spaces or multiple nested spaces. The automation device may be on a floor in a room. Spaces may be a special use case tag.

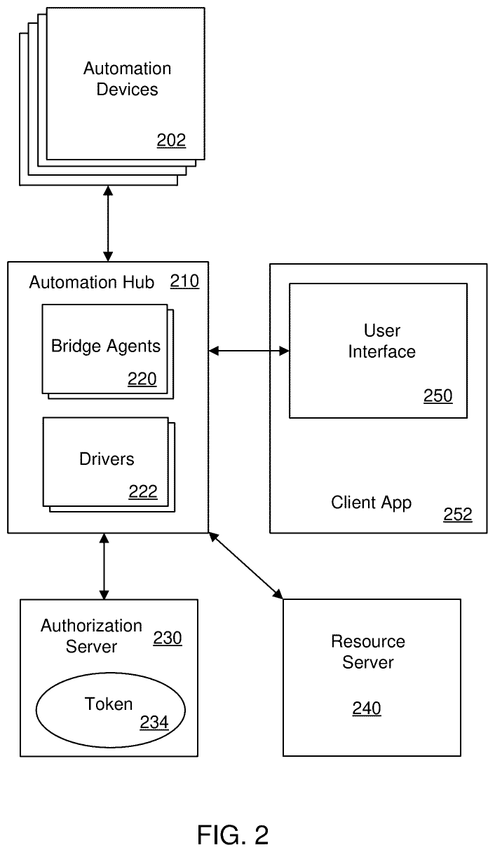

FIG. 2 illustrates that this technology may use a bridge agent 220 or bridge process executing on an automation hub 210 (e.g., a physical controller) or another services hub in a location in order to discover what automation devices 202 are on the network and what services are available from the automation devices 202 or through the network. The bridge agent 220 may use SSTP (Secure Socket Tunneling Protocol) discovery requests or DDN (digital data network) requests to identify automation devices 202 connected to the local network that are not managed by the automation hub 210 yet. While two specific discovery methods are described, there are many other ways to discover automation devices or other devices on the local network.

In one example, a bridge agent 220 executing on the automation hub 210 may find out there is a NEST thermostat that is connected to the network. Then the automation hub 210 may send a message to a user through a mobile device, an automation control panel or a similar management application. The message may initiate a pop-up question for the user and ask if the user wants to set up the discovered device to work with the automation hub 210 or automation system.

If the user does want to add the automation device 210 to the automation network, then the next operation is to configure the automation device 202 by executing a configuration process that sends configuration process step instructions to a user interface 250 for a user application 252. For example, as part of a configuration process, the configuration interface may collect credentials from a user for an authorization process (e.g., OAuth) by executing a user interface 250 or configuration application on the client application 252. Those credentials may be sent to an authorization server 230 (e.g., an OAuth server) for the NEST device. The NEST authorization server 230 may be in a cloud (e.g., a public cloud or a private cloud) and a cloud-to-cloud communication can occur between the cloud server for the automation hub 210 and the NEST authorization server 230 for the NEST device. Alternatively, the automation hub 210 may communicate directly with the NEST authorization server 230 in the cloud.

In the case of a single device (e.g., the NEST device) with a simple authorization interface, the authorization process may have the user answer a few more questions and the authorization may occur. Specifically, the automation device 202 and/or automation hub 210 (or automation server) in the cloud can have a configuration process and pop-up the OAuth interface for the device through the user interface 250 of the client application 252. Then the authorization request re-directs to the authorization server 230 for the desired device or API service. In this scenario, the automation hub 210 or automation server can make a request to Google for the NEST device to request a proxy for the users of the automation device 202. The request states that the user wants to control a NEST Thermostat through Google's automation service and provides the user's authorization collected through the user application 252 and user interface 250. The automation hub 210 or app can collect credentials for authorization in a browser on the user application 252 and a user can provide their password. Specifically, the automation hub 210 or server has access to an OAuth page (or API) and a URL. Then a token 234 or access token can be received back from the authorization service (e.g., Google for the NEST device). The token 234 or access token may be used to make API calls to a resource server 240 for the authorized person on this account and for the automation device 202. The token 234 may be used by the automation hub 210 to control the automation device 202. Alternatively, the token 234 may be used by an automation hub 210 or server to make API calls the cloud to control the automation device 202 on the local automation network.

The token 234 may need to be refreshed periodically and a new token may be obtained by using the old token to obtain a new token within a certain time period. Obtaining the token 234 allows the automation service and/or automation hub 210 to control the users'automation device(s) on an ongoing basis.

One challenge is that the processes for configuring automation devices and obtaining tokens 234 for accessing multiple services that support a wide variety of automation devices can vary depending on the vendor or the specific automation device 202. Sometimes, the OAuth token can be obtained by collecting the user name and password in the automation service's UI 250 or automation hub's UI, and then the automation hub or automation service can make an API call and a token is received back. In other cases, the authorization service for an automation device 202 may dictate that the requesting service or device to go through their vendor's web page and go through defined steps to obtain the desired token. Some authorization services may require 2 factor authentication (2FA), while other authorization services may use authenticator app information. Yet other authorization services may require biometric authorization information or other very detailed authorization processes. In the future, additional authorization processes and methods may also be developed. As a result, it can be difficult for a bridge agent 220 or an automation hub 210 or server that identifies a new automation device 202 to know what configuration process should be executed to get the authorization token for that specific automation device and/or device vendor.

A bridge agent 220 for an automation hub 210 may detect an automation device 202 and use the identification information from that device (e.g., device name, device ID, network address, etc.) to look up the exact automation device identifiers and specifications. The bridge agent 220 can work through multi-step processes to connect and configure automation devices 202 to be managed and controlled through the bridge agent 220. For example, the bridge agent 220 may be programmed to initiate user interface 250 controls on a client application 252 to collect desired configuration information. In the example of 2FA (two factor authentication), then the configuration process may have a user enter their user name and password. Then in a second example step, the user may be presented with a user interface control to enter the 2FA (e.g., a password, pin, biometrics or a hardware key). The bridge agent 220 with the configuration process that sends user interface prompts to the client application 252 may use any number of steps to complete the configuration. This provides an automated configuration system where the user interface (UI) 250 on the client application 252 does not need to know anything about the automation device 202. However, the bridge agents 220 can supply a variable number of steps in the configuration process for an automation device 202 in order to configure any automation device 202 no matter how many steps or what type of steps the automation device 202 needs for configuration. Because the UI 250 on the client app 252 does not need know everything about the configuration process for every possible device, the client application 252 can just present the type of user interface and number and details of operations in the user interface 250 that are needed. For example, when the manufacturer Ring builds an app for their device, Ring knows 2FA is used for configuring the device. The bridge agent 220 will have this configuration detail in the process for configuring the Ring device. The bridge agent 220 is architected to deal with all different types of devices. So, devices from Z-Wave can use steps for configuration, and devices from Ring can use 3 different steps that the UI presents but both of these processes can be easily accommodated using a separate bridge agent 220 for each device vendor, for example.

The automation hub 210 can receive information about the type of configuration processes to be used for that automation device 202 or product from the bridge agent 220. Specifically, the automation hub 210 may learn what type of OAuth process is to be used. The automation device 202 can also notify the automation hub 210 about whether the automation device 202 uses a URL, whether the automation device 202 uses a user name and password, whether biometric authentication is used, whether dual factor authentication is needed, and/or what type of dual factor authentication is being used. This way the bridge agent 220 or bridge service guides the UI of the client app 252 through the steps of the process.

Providing information about a type of configuration process or functions in a configuration process from the bridge agent 220 to a client application 252 and/or automation hub 210 avoids the need for developers to create a full UI and/or a full cloud structure for each type of device. In one example, the bridge agent 220 may tell the automation hub 210 or automation server what type of OAuth device is being connected. Then the authentication software on the automation hub 210 can execute the process for authentication with the variations needed for the identified automation device 202.

In a more specific example, the bridge agent 220 may tell the client application 252 what type of configuration steps (e.g., authentication steps, authorization steps) or operations occur for the automation device 202 being loaded. Then the client application 252 may present those corresponding UI 250 items and/or execute the related OAuth information collection interface used by the vendor of the automation device for a user. For example, the software may be executing locally on the automation hub, and/or the software or bridge agent 220 can set up the steps for the UI and client app 252 to talk to cloud authorization process on an authorization server 230 and get the token 234 back. The token 234 can then be handed back to the software on the automation hub 210 on the local premise to enable the automation hub 210 to talk to that service for the automation device 202 and to control the automation device. The service to control the automation device 202 may be on a resource server 240 accessible to the automation hub 210 with the token 234.

In one configuration, the bridge agent 220 may be programmed with the processes used to configure each automation device 202 (e.g., OAuth authentication and authorization). This data may be stored in memory for the bridge agent 220 or stored on a computer readable medium such as local or networked non-volatile storage that is accessible to the bridge agent 220.

In a further embodiment, the configuration process may occur using an automation server in the cloud or a cloud based service. The automation hub may report to an automation service (e.g., in a public or private cloud) regarding which automation devices are on its network. The automation service may determine the configuration process needed by the automation hub and an automation device and initiate that process from the cloud. More specifically, the automation service may determine the type of configuration process used by the vendor of a particular automation device connected to the automation hub. Then the automation service may execute the correct process to collect the data that is needed for the automation devices 202. In one example, the automation service may use the authentication credentials collected to obtain a token from an authorization server of the vendor of the automation device. The token can be used by the automation service and/or the automation hub in order to access services for the automation device and control the automation device through the vendor's resource server 240 or vendor's service API associated with the automation device 202.

In one example, FIG. 2 illustrates that an automation hub 210 or controller has a process executing to manage communication and there are multiple bridges and drivers (e.g., objects) that are plug-ins for the automation hub and process. For example, a Lutron dimmer may exist on the Lutron network and the Lutron gateway may be in wireless communication with the dimmer. There may be a physical switch connected to the gateway that connects the gateway to an IP network. The controller or automation hub 220 is on the IP network. Inside the automation hub or controller is a process that can execute a bridge agent 220 and a driver 222 for that dimmer. That driver knows how to talk to a Lutron dimmer or switch. Since it is a Lutron switch, then the packets are sent through the Lutron bridge agent and then to the physical Lutron gateway to get to the Lutron device.

In another embodiment, there may be a bridge agent 220 to do discovery and configuration for certain types of devices (e.g., dimmers). Then there may be a driver 222 for a generic Wi-Fi dimmer and the driver uses the bridge agent to discover devices (DHCP to get IP address) then the driver can communicate directly to the dimmer device through the network. Accordingly, the bridge agent 220 may perform only discovery. The bridge agent can perform the discovery and know how to encapsulate the packets to send to the IP gateway for a group of devices.

In further embodiments, there may be a bridge agent that is embodied in software services in the cloud or a software gateway. For example, Google and Sonos have a software bridge or bridge in the cloud. Google and Sonos have a bridge agent but they are cloud services (and not a gateway). The software service sends messages back through internet to control and communicate with the device.

Some devices can communicate on a local network alone (e.g., a Roku device). Zigbee and Z-Wave work the same way as Lutron devices, but use the radios in the automation devices or other devices. This means the bridge agent knows how to talk to hub radio (in the gateway or hub) that knows how to talk to radios in the automation devices. The wireless bridge talks to the radio that talks to the device. In one example, the wireless bridge may be inside the automation hub box rather than outside the automation hub or the wireless bridge can be accessed through an IP network. A Z-Wave bridge with a Z-Wave light switch driver can communicate to the Z-Wave radio and then to the Z-Wave radio of the automation device. The automation hub may be sending data to a serial port for wireless output instead of an IP network, if desired.

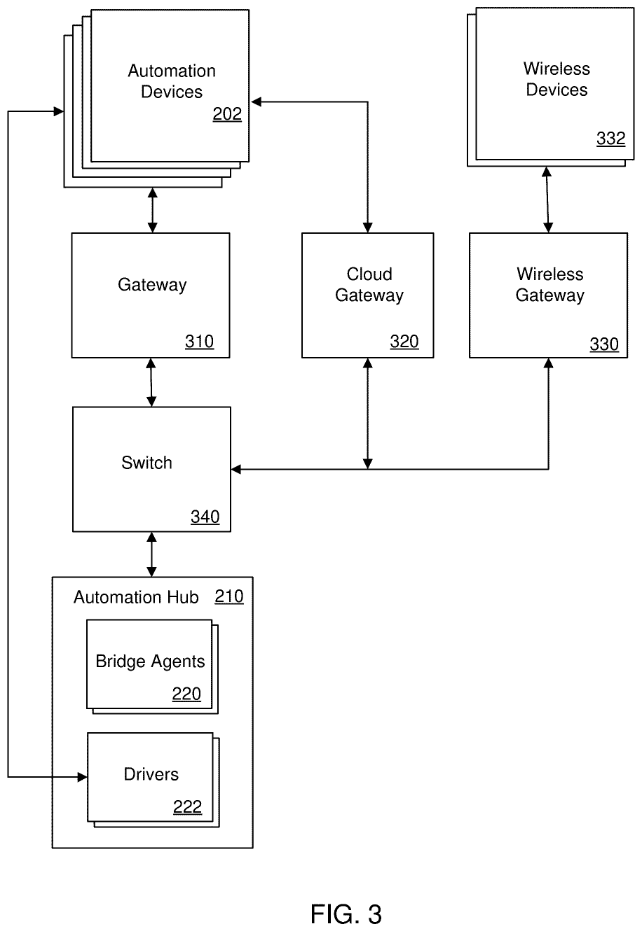

FIG. 3 illustrates the various types of gateways that may be connected to an automation hub. In one example, the automation hub can communicate through a hardware switch 340 for the IP network and then to a vendor gateway 310 which can in turn communicate with the automation devices 202. Alternatively, a cloud gateway 320 can be communicated with by the automation hub 210 and requests or API calls may be sent to the cloud gateway to control the automation devices 202. A token may be needed for authorization to control the devices. The automation hub 210 may also communicate with a wireless gateway 330 that further communicates with wireless devices 332 for automation.

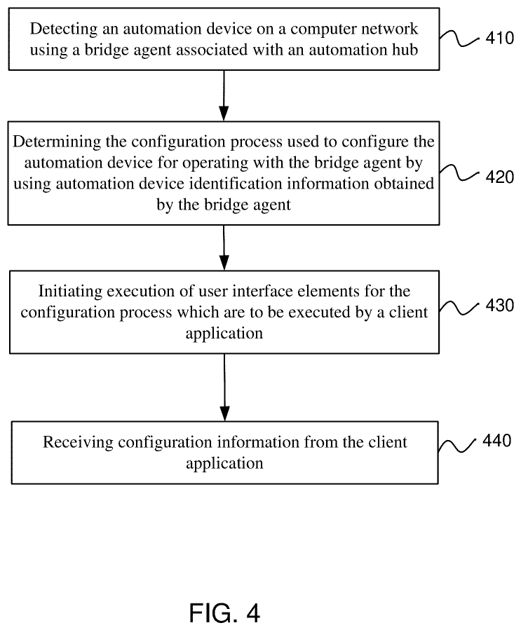

FIG. 4 illustrates a method for determining a configuration process for an automation device. An automation device on a computer network can be detected using a bridge agent associated with an automation hub, as in block 410. A bridge agent for a type of automation device detected may be loaded, as needed. For example, if a Lutron device is detected but no Lutron devices are being used yet, then the bridge agent can be loaded as a plug-in.

The configuration process may be used to configure the automation device for operating with the bridge agent and the configuration process needed may be determined by using automation device identification information obtained by the bridge agent, as in block 420.

In one example, a type of authorization interface may be identified. Initially, the bridge agent may query the automation device to determine a device type of the automation device. The bridge can then determine a configuration interface type for the device type. In one example, configuration data (including authentication and/or authorization data) that was obtained from a user through a client application may then be sent to an authorization server.

Execution of user interface elements for the configuration process may be initiated by the bridge agent, and then the interface elements may be executed by a client application, as in block 430. In one example, an authorization interface using a type of authorization interface determined for the automation device may be initiated by the automation hub in order to collect authentication and/or authorization information for completing authorization to access third-party services or a resource server. In another example, a user interface may be presented to a user by the client application on a client device based on a template to collect data based on the authorization interface type.

Configuration information from the client application may be received by the bridge agent, as in block 440. The configuration information may be used to connect the automation device to an automation hub. The bridge agent can store and present the UI in a fairly simple way. The configuration process can be stored as a process containing what the steps are and what needs to happen for each operation. This process is passed to the client application either a step at a time or as an entire process for one automation device. Then a client application and client device can be used to configure new automation devices without knowing any specific details about the automation device(s). In other words, the bridge agent can send the steps regarding information to be collected to the client application on the client device.

The user may indicate that the user wants to add a device or a device has been detected. If the device is a Nest device, then the automation hub can load the Nest bridge agent. The configuration tool may be started and the configuration tool in the bridge agent tells the client application the UI the steps that are going to be used on a step-by-step basis, and these steps tell the client application what UI to present to the user to collect configuration information and what to do. The client application may be a mobile app on a mobile phone device, a tablet, a laptop, or another computing device. In one example, the client may only receive and provide one step at a time to a user. If there is an error in collecting the configuration information, then the client application can loop back to previous step or logic with the error for checking or correcting what was received.

After a full detection and configuration cycle, then the automation hub may report that 2 Nest thermostats, a doorbell and a smoke detector have been connected to and configured for the automation hub. So, each device initially detected on the network may have been added. At another point in time, the automation hub might detect or find 10 new devices on the network, then the automation hub can go through the entire process of configuring the new devices on the network. The configuration may include authenticating and connecting to a third party service to control the automation devices (or just pushing a button on the device) and adding the device into the system. The UI of the client application does not need to know the exact configuration process for each device because the exact steps and operations can be provided by the bridge agent on the automation hub.

Similarly, the user can ask the automation hub to add the devices. When a device is added, the device can go through the configuration process and add the device. If the new device is for a vendor for which a token has been received from an authorization service, then the bridge agent can use the tokens already received to add the device. If authentication to an authorization server is needed to obtain a token then that process may be undertaken.

Each bridge agent may be programmed to have a configuration process for each device belonging to the device type or device group which the bridge agent manages or controls. As discussed earlier, there may be a bridge agent for each type of item. In one example, there may be a bridge agent for each vendor or service provider, such as Lutron, Phillips, Google, Alexa, etc. The bridge agent can be updated or adapted for any new device. When new devices in a device type or classification are created (e.g., by a vendor) then the bridge agent may be updated and the plug-in may re-load with the new device information.

The bridge may be a plug-in that represents a network of devices. The drivers often talk through the bridges. For example, a Lutron dimmer driver may know how to talk to dimmer but the dimmer driver communicates through the bridge agent so the instructions can be translated to Lutron specific protocols. If Lutron comes out with a new device (e.g., blinds), the new device can be communicated with through the bridge agent. As discussed, the driver and bridge agent can be on the automation hub or automation controller.

There may also be a physical bridge device that may be embodied in a gateway for communicating with an automation device type, as described earlier. The software bridge is the logical analog of the gateway and communicates with the hardware gateway (e.g., a Lutron gateway). The logical bridge or software bridge also has drivers to communicate with automation devices. The logical driver is on the controller and the logical bridge agent is on the controller.

Google and some other device vendors have an API in the cloud and all devices talk to the cloud and must receive instructions through the cloud. The automation hub can authenticate to Google Home cloud and the Google Home cloud can report all the devices already in the Google home group for a specific account. In effect, the Google cloud acts in the place of a hardware bridge.

Some bridge agents in this technology only discover the automation devices and the driver may talk directly to the automation device. For example, if the device is on the local network, then the driver does not need to go through the bridge agent to talk to the automation device. In contrast, a vendor such as Lutron has their own physical bridge device, which is a gateway that translates from the IP protocol to their own proprietary communication format. In another example, Z-Wave does the same thing by providing an IP to Z-wave bridge.

There may also be a driver in each of the automation devices. Sometimes a software driver in the automation hub can talk to a software bridge or to the automation device directly. For example, a Lutron driver in the automation hub can talk to the bridge which talks to Lutron's gateway which talks to the physical automation device. As discussed, the software bridge knows how expose what devices are in the specific network (e.g., Lutron network) and how to connect, configure, authenticate and what to do.

The configuration information may also include authentication information that can be sent to the authorization server. A token (e.g., an access token) may be received by the bridge agent from the authorization server. The token may be used to access third-party services for the automation device. More specifically, the token may be used to authorize services provided by a resource server. In another example, the token may be used to make API calls to cloud services for the authorized person on an account or for the automation device. The technology may also be used for removing devices.

Certain processes may be followed to remove devices from the automation hub. The bridge agents can be programmed with process steps for removing a specific type of device. For example, in the Z-Wave protocol, once the device is in the network, the wireless device must be unpaired from the current network before the device can join another network. The unpairing may be physically touching a button on the device or providing a password or code to complete the unpairing. Such information may be provided by the user application to the bridge agent in order for the unpairing to take place.

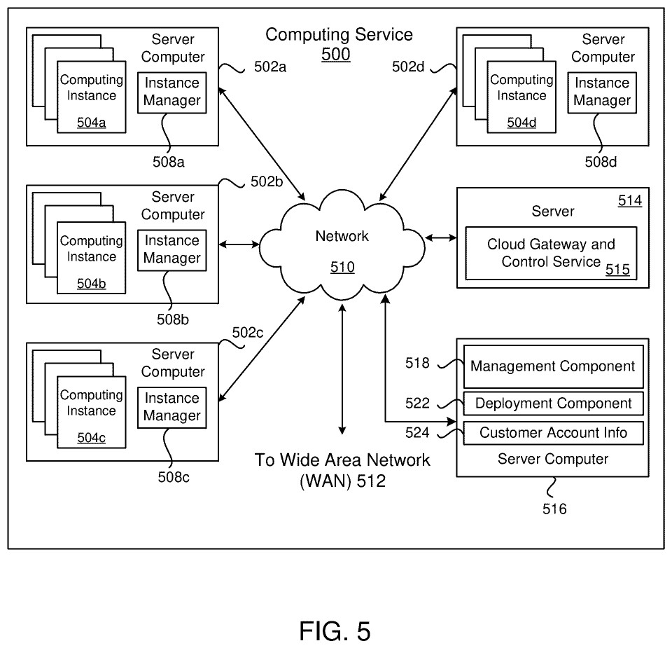

FIG. 5 is a block diagram illustrating an example computing service 500 that may be used to execute and manage a number of computing instances 504a-d upon which the present technology may execute. In particular, the computing service 500 depicted illustrates one environment in which the technology described herein may be used. The computing service 500 may be one type of environment that includes various virtualized service resources that may be used, for instance, to host computing instances 504a-d.

The computing service 500 may be capable of delivery of computing, storage and networking capacity as a software service to a community of end recipients. In one example, the computing service 500 may be established for an organization by or on behalf of the organization. That is, the computing service 500 may offer a “private cloud environment.” In another example, the computing service 500 may support a multi-tenant environment, wherein a plurality of customers may operate independently (i.e., a public cloud environment). Generally speaking, the computing service 500 may provide the following models: Infrastructure as a Service (“IaaS”) and/or Software as a Service (“SaaS”). Other models may be provided. For the IaaS model, the computing service 500 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 500. End customers may access the computing service 500 using networked client devices, such as desktop computers, laptops, tablets, smartphones, etc. running web browsers or other lightweight client applications, for example. Those familiar with the art will recognize that the computing service 500 may be described as a “cloud” environment.

The particularly illustrated computing service 500 may include a plurality of server computers 502a-d. The server computers 502a-d may also be known as physical hosts. While four server computers are shown, any number may be used, and large data centers may include thousands of server computers. The computing service 500 may provide computing resources for executing computing instances 504a-d. Computing instances 504a-d may, for example, be virtual machines. A virtual machine may be an instance of a software implementation of a machine (i.e. a computer) that executes applications like a physical machine. In the example of a virtual machine, each of the server computers 502a-d may be configured to execute an instance manager 508a-d capable of executing the instances. The instance manager 508a-d may be a hypervisor, virtual machine manager (VMM), or another type of program configured to enable the execution of multiple computing instances 504a-d on a single server. Additionally, each of the computing instances 504a-d may be configured to execute one or more applications.

A server 514 may be reserved to execute software components for implementing the present technology or managing the operation of the computing service 500 and the computing instances 504a-d. For example, the server 514 may include a cloud gateway and control service 515 to control automation device.

A server computer 516 may execute a management component 518. A customer may access the management component 518 to configure various aspects of the operation of the computing instances 504a-d purchased by a customer. For example, the customer may setup computing instances 504a-d and make changes to the configuration of the computing instances 504a-d.

A deployment component 522 may be used to assist customers in the deployment of computing instances 504a-d. The deployment component 522 may have access to account information associated with the computing instances 504a-d, such as the name of an owner of the account, credit card information, country of the owner, etc. The deployment component 522 may receive a configuration from a customer that includes data describing how computing instances 504a-d may be configured. For example, the configuration may include an operating system, provide one or more applications to be installed in computing instances 504a-d, provide scripts and/or other types of code to be executed for configuring computing instances 504a-d, provide cache logic specifying how an application cache is to be prepared, and other types of information. The deployment component 522 may utilize the customer-provided configuration and cache logic to configure, prime, and launch computing instances 504a-d. The configuration, cache logic, and other information may be specified by a customer accessing the management component 518 or by providing this information directly to the deployment component 522.

Customer account information 524 may include any desired information associated with a customer of the multi-tenant environment. For example, the customer account information may include a unique identifier for a customer, a customer address, billing information, licensing information, customization parameters for launching instances, scheduling information, etc. As described above, the customer account information 524 may also include security information used in encryption of asynchronous responses to API requests. By “asynchronous” it is meant that the API response may be made at any time after the initial request and with a different network connection.

A network 510 may be utilized to interconnect the computing service 500 and the server computers 502a-d, 516. The network 510 may be a local area network (LAN) and may be connected to a Wide Area Network (WAN) 512 or the Internet, so that end customers may access the computing service 500. In addition, the network 510 may include a virtual network overlaid on the physical network to provide communications between the servers 502a-d. The network topology illustrated in FIG. 5 has been simplified, as many more networks and networking devices may be utilized to interconnect the various computing systems disclosed herein.

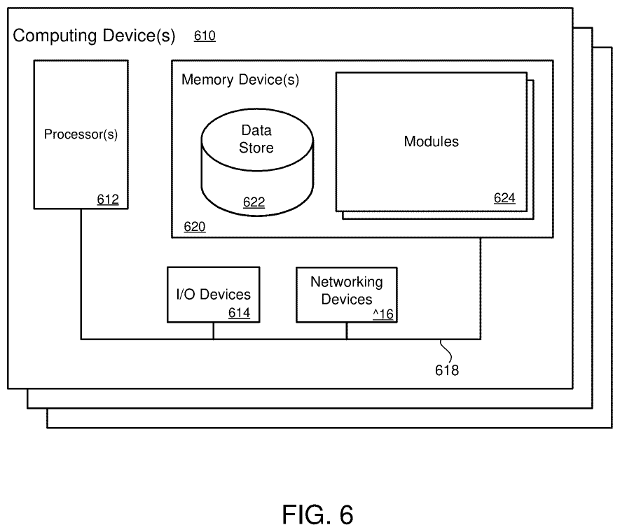

FIG. 6 illustrates a computing device 610 on which modules of this technology may execute. The computing device 610 is illustrated on which a high level example of the technology may be executed. The computing device 610 may include one or more processors 612 that are in communication with memory devices 620. The computing device may include a local communication interface 618 for the components in the computing device. For example, the local communication interface may be a local data bus and/or any related address or control busses as may be desired.

The memory device 620 may contain modules 624 that are executable by the processor(s) 612 and data for the modules 624. The modules 624 may execute the functions described earlier. A data store 622 may also be located in the memory device 620 for storing data related to the modules 624 and other applications along with an operating system that is executable by the processor(s) 612.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for executing a configuration process for an automation device, comprising:
detecting the automation device on a computer network using a bridge agent associated with an automation hub;
determining the configuration process used to configure the automation device for operating with the bridge agent by using automation device identification information obtained by the bridge agent;
initiating execution of the configuration process which is to be executed by a client application; and
receiving configuration information for the automation device from the client application.

2. The method as in claim 1, further comprising sending authorization information from the configuration information to an authorization server.

3. The method as in claim 2, further comprising receiving a token from the authorization server.

4. The method as in claim 3, further comprising using the token to access third-party services for the automation device.

5. The method as in claim 1, wherein initiating execution of user interface elements further comprises: initiating an authorization interface using a type of authorization interface determined for the automation device by the automation hub in order to collect authorization information for completing authorization.

6. The method as in claim 4, wherein determining a type of authorization interface, further comprises:
querying the automation device to determine a device type of the automation device;
determining an authorization interface type for the device type;
obtaining authorization data to send to an authorization server from a user through a client application; and
sending the authorization data to the authorization server.

7. The method as in claim 1, further comprising, presenting a user interface to a user based on a template to collect data based on an authorization interface type.

8. The method as in claim 1, further comprising connecting the automation device to an automation hub.

9. The method as in claim 6, wherein the token is used to make API calls for an authorized person on an account or for the automation device.

10. The method as in claim 1, further comprising loading a bridge agent for a type of automation device detected.

11. A method for providing an interface to enable obtaining a token from an authorization service, comprising:
detecting an automation device on a computer network using a bridge agent associated with an automation hub;
determining a type of authorization interface used to authenticate to an authorization server of a vendor of the automation device by using automation device identification information received by the bridge agent;
initiating the authorization interface using the type of authorization interface and the automation hub to collect authorization information for completing authentication;
sending the authorization information to the authorization server; and
receiving the token from the authorization server.

12. The method as in claim 11, wherein determining a type of authorization interface, further comprises:
querying the automation device to determine a device type of the automation device;
retrieving an authorization interface type;
obtaining authorization data to send to an authorization server from a user; and
sending the authorization data to the authorization server.

13. The method as in claim 11, wherein retrieving an authorization interface type further comprises looking up an authorization interface type in a data store using a device type.

14. The method as in claim 11, further comprising, presenting a user interface to a user based on a template to collect data based on an authentication interface type.

15. The method as in claim 11, further comprising connecting the automation device to an automation hub.

16. A system for determining an authorization process to enable obtaining authorization from an authorization service, comprising:
at least one processor;
at least one memory device including a data store to store a plurality of data and instructions that, when executed, cause the system and processor to:
detect an automation device on a computer network using a bridge agent associated with an automation hub;
determine the authorization process used to authenticate to an authorization server of a vendor of the automation device by using automation device identification information received by the bridge agent;
initiate execution of user interface elements of the authorization process to be executed by a client application; and
receive authorization information from the client application.

17. The system as in claim 16, further comprising sending the authorization information to the authorization server.

18. The system as in claim 17, further comprising receiving a token from the authorization server.

19. The system as in claim 18, further comprising using the token to access third-party services for the automation device.

20. The system as in claim 19, wherein the token is used to make API calls for an authorized person on an account or for the automation device.
